(19) United States
(12) Patent Application Publication
(10) Pub. No.: US 2011/0009527 A1
(43) Pub. Date: Jan. 13, 2011

(54) THERMOSETTING COMPOSITIONS COMPRISING SILICONE POLYETHERS, THEIR MANUFACTURE, AND USES

(76) Inventors: Bernd Hoevel, Sinzheim (DE); Ludovic Valette, Lake Jackson, TX (US); Patricia L. Roberts, Columbia, MO (US)

Correspondence Address: The Dow Chemical Company, P.O. BOX 1967, 2040 Dow Center, Midland, MI, 48641, US

(21) Appl. No.: 12/866,192

(22) PCT Filed: Feb. 2, 2009
(86) PCT No.: PCT/US09/32820

§ 371 Date: Aug. 25, 2010

Related U.S. Application Data
(60) Provisional application No. 61/028,932, filed on Feb. 15, 2008.

(51) Int. Cl. C08L 83/06; C08L 63/00; C08K 3/34; C08K 3/22

(52) U.S. Cl. 523/400; 524/500; 524/506; 524/502; 524/451; 524/449; 524/437; 524/436

(57) ABSTRACT

Thermosetting compositions comprising a) at least a first thermosetting resin, b) at least one silicone polyether, and c) at least one filler or fibrous reinforcement, methods of making such thermosetting compositions, and thermoset products made from the compositions.

### FIELD OF THE INVENTION

The present invention relates to thermosetting compositions comprising thermosetting resins, silicone polyethers, and fillers.

### BACKGROUND OF THE INVENTION

With the introduction of the RoHS (Restriction of the use of certain Hazardous Substances in electrical and electronic equipment) Directive in several countries around the world, the soldering of electronic equipment has become in large part lead free. In conjunction with this change, non-dicynadiamide (mostly phenolic) FR-4 (woven glass and epoxy) base materials for printed wire board manufacturing are now preferred. This change in the resin matrix is often accompanied by a higher brittleness of the resin system. The higher brittleness leads to some processing difficulties which are primarily associated with drilling and grinding, and which can lead to subsequent failures like Conductive Anodic Filament (CAF) growth, resin recession, and pad lifting.

In view of these problems, there remains a need in the art for improved thermosetting compositions.

### SUMMARY OF THE INVENTION

The present invention provides thermosetting compositions and thermoset networks exhibiting improved mechanical performance, especially enhanced drillability, while maintaining good processability, especially lower melt viscosity of the solid varnish composition. Preferably, the improved performance is exhibited by filled epoxy-based systems.

Most of the conventional toughening agents used in thermosetting compositions (rubber, core-shell particles, thermoplastic block polymers) do not combine very well with filler, as the toughening polymer is often high in molecular weight in order to function. The addition of filler to thermoset formulations comprising conventional toughening agents can therefore further increase the viscosity, often leading to unacceptably high viscosity for processing. Moreover, the introduction of filler into epoxy resin matrices comprising a toughening agent (or, in some instances, more than one toughening agent) can reduce the agent's toughening effect.

The present invention provides at least the following advantages and features:

The present invention combines toughness and good processability with the use of fillers. The present invention also exhibits excellent mechanical properties, especially when used with a filler. The silicone polyether of the present invention in combination with filler also has an effect at surprisingly low load levels. In addition, the present invention can be coated. Furthermore, the filler can be pre-coated with a silicone polyether for enhanced toughening. The present invention also allows for glass and prepreg surface modifications with advantageous effects.

These features and advantages are provided at least by the following specific embodiments: A thermosetting composition including:

a) at least a first thermosetting resin,
b) at least one silicone polyether, wherein the silicone polyether comprises the following structure (I):

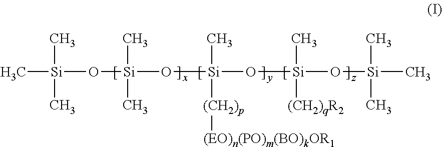

wherein x, y, z, p, q, k, m, and n may be independent integers; x and y may be greater than or equal to 1; z may be greater than or equal to 0; p and q may be greater than or equal to 1; k, n, and m may be greater than or equal to 0 and the sum of k+n+m may be greater than or equal to 1; R₁ and R₂ may be independent end groups chosen from H or H function groups comprising —OH—NH₂ or NHR, (CH2)nCH3 where n is an integer greater than or equal to 0 and R represents any one of the alkyl groups, acetate, and (meth)acrylate; and EO is ethylene oxide, PO is propylene oxide, and BO is butylene oxide; and
c) at least one filler or at least one fibrous reinforcement.

The invention seeks to improve the mechanical performance of epoxy resin compositions containing at least one silicone polyether as described herein. Other features and advantages of the present invention will be set forth in the description of the invention that follows, and will be apparent, in part, from the description or may be learned by practice of the invention. The invention will be realized and attained by the compositions, products, and methods particularly pointed out in the written description and claims hereof.

### BRIEF DESCRIPTION OF THE DRAWINGS

FIG. 1 shows exemplary results of Cu-peel and adhesion analysis for formulations comprising filler.

FIG. 2 shows exemplary results of Cu-peel and adhesion analysis for non-filled formulations.

FIG. 3 shows exemplary punch test results.

### DETAILED DESCRIPTION OF THE INVENTION

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

As noted above, changes in resin matrices used in base materials compliant with the RoHS Directive are often accompanied by a higher brittleness of the resin system. The higher brittleness leads to some processing difficulties, including difficulties associated with drilling and grinding, as well as difficulties leading to subsequent failures like Conductive Anodic Filament (CAF) growth, resin recession, and pad lifting.

The present invention provides thermoset networks exhibiting significant, and in some instances surprising, improvements over conventional thermoset networks, especially when fillers are used in combination with the silicone polyethers described herein. The present invention describes the use of silicone polyether resins in thermosetting compositions. Preferably the thermosetting composition is epoxy-based. Preferably the composition contains inorganic filler.

### Silicone Polyether of the Instant Invention

The silicone polyether resins of the present invention impart greater processability and excellent toughening properties upon thermosetting compositions. The silicone polyether resins also maintain such properties after the addition of filler to the formulation. Most conventional toughening agents, such as rubbers, core-shell particles, and thermoplastic block polymers, have a high molecular weight to initiate suitable toughening mechanisms. The high molecular weight, however, has an undesirable effect on the viscosity of the uncured thermoset formulation. The increase in viscosity is exacerbated by the addition of filler to the composition. Because of the high viscosity, these formulations are less desirable for compositions that need to diffuse into the glass cloth. It is surprising that silicone polyether resins with low molecular weight and/or low viscosity, which impart greater processability, maintain excellent toughening properties.

Remarkably, the silicone polyether resins of the present invention maintain their ability to impart greater processability and excellent toughening properties even after filler is added to the formulation. This stands in contrast to the use of conventional tougheners which do not combine well with filler. For example, the toughening effect of rubber-containing block copolymers decreases when filler is introduced into the formulation. Furthermore, the effective use level of the silicone polyether resins in conjunction with fillers is very low compared to other toughening reagents like rubber or block co-polymers. The lower viscosity of the silicone polyethers as compared to other toughening agents also enables higher load levels of filler, while maintaining high processability and mechanical properties. Indeed, because the silicone polyether acts as a dispersant, the decrease in viscosity is also observed in systems comprising one or more fillers.

However, the silicone polyether resins of the instant invention have also been found to act as efficient toughing agents for the epoxy network even in conjunction with fillers. Thus, not only does the presence of silicone polyether resins enable higher toughness when compared to unmodified thermoset networks, such compositions show a lower melt viscosity than compositions containing conventional block copolymer toughening agents, leading to better processability and easier handling.

Use of the silicone polyether in thermosetting compositions comprising at least one filler has an effect at surprisingly low load levels. For example, the silicone polyether can be used together with filler at load levels of about 0.1% or lower, such as, for example, 0.09%, 0.08%, 0.07%, 0.06%, 0.05%, 0.04%, 0.03%, 0.02%, or 0.01%.

The silicone polyether also has the ability to wet out inorganic OH-functional surfaces, such as SiO2 and AlOOH. It therefore can reduce the viscosity of a filler-modified resin system.

According to the present invention, a silicone polyether additive can be grafted in the thermoset network through the reactive groups. Most of the conventional tougheners are not reactive—they are physically linked to the network (by entanglement) but not chemically bonded. In embodiments of the present invention, the silicone polyether can be reactive with the thermoset system and consequently be incorporated into the final network. Migration of the toughening agent is prevented, even at high temperature.

The silicone polyether resins of the instant invention also create suitable phase separation for grafting. When block polymers are conventionally used as toughening agents, a specific sequence of blocks is relied upon to enable proper phase separation. In the instant embodiments, it is surprising to see that the silicone polyether resins create suitable phase separation when grafted.

Some improvements observed with the instant embodiments may relate to the use of silicone polyethers, and more particularly, to the use of silicone polyethers having preferred structures, especially in epoxy base laminates and other thermoset products. The thermoset products may optionally contain fillers or fibrous reinforcements. The silicon polyether structures of the invention appear to act as toughening agents, imparting excellent mechanical properties and reducing moisture uptake in the thermoset network, while maintaining low viscosity in the uncured composition, even when used in combination with filler. The presence of the silicone polyethers, as used herein, imparts greater toughness and lower moisture uptake, as compared to thermoset networks lacking the silicone polyethers.

To provide context for the following detailed description, some definitions may be helpful. “Thermosetting compositions” are compositions that include elements that may be included and mixed together, or reacted, to form a “thermoset product.” As some of the elements of a “thermosetting composition” may react with one or more of such elements, the original elements of a thermosetting composition may no longer be present in the final “thermoset product.” A “thermoset product” will generally include a “thermoset network,” which is descriptive of the structure formed by a “thermosetting resin,” examples of which are well known in the art.

### Thermosetting Compositions

The invention provides thermosetting compositions comprising a) at least a first thermosetting resin, b) at least one silicone polyether, wherein the silicone polyether comprises the following structure:

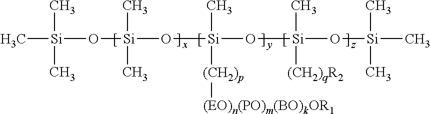

where EO is ethylene oxide, PO is propylene oxide, and BO is butylene oxide; and c) at least one filler or at least one fibrous reinforcement.

In an alternative embodiment, the thermosetting composition does not comprise a filler or fibrous reinforcement.

R1 and R2 may be independent end groups chosen, for example, from H or H function groups including —OH, —NH₂ or NHR, (CH2)nCH3 where n is an integer greater than or equal to 0 and R represents any one of the alkyl groups, acetate, or (meth)acrylate. In alternative embodiments, R1 and R2 may be independent end groups chosen from H, CH₃, and acetate.

The values of x, y, z, p, q, k, m, and n may be independent integers; x and y may be greater than or equal to 1; z may be greater than or equal to 0; p and q may be greater than or equal to 1; and k, n, and m may be greater than or equal to 0 and the sum of k+n+m may greater than or equal to 1. The value of z may range from 0 to 50, 0 to 45, 0 to 40, 0 to 35, 0 to 30, 0 to 25, 0 to 20, 0 to 15, 0 to 10, 0 to 5, and may be 0. The values of x and y may be independent integers and they may range from 1 to 2000, 2 to 1000, 5 to 800, 10 to 600, or to 400. The sum of x+y may range from 1 to 2000, 2 to 1000, 5 to 800, 10 to 600, or 20 to 400. The values of p and q may be independent and range from 1 to 10, such as 1, 2, 3, 4, 5, 6, 7, 8, 9, or 10, and from any number to any number, such as, for example, from 2 to 7, or from 2 to 5; in some embodiments, both p and q are 3. The sum of n+m may be greater than or equal to 1 and k may be equal to 0.

The values of x, y, p, and q may be independently chosen such that the average molecular weight of the at least one silicone polyether is from about 400 to about 100,000, or about 600 to about 60,000, or from about 1,000 to about 50,000, or from about 2,000 to about 30,000. The values of x, y, p, and q may be independently chosen such that the percentage by weight of silicone backbone in the at least one silicone polyether is from about 5% to about 95%, or from about 10% to about 90%, or from about 15% to about 60%. The values of x, y, p, and q may be independently chosen such that the average molecular weight of the silicone backbone in the at least one silicone polyether is from about 200 to about 30,000, or from about 500 to about 15,000, or from about 700 to about 6,000.

The at least one silicone polyether is generally chosen such that its viscosity, when measured in accordance to A.S.T.M. D445, at 25° C., is from about 1 cSt to about 50,000 cSt, or from about 5 cSt to about 10,000 cSt, or from about 10 cSt to about 6,000 cSt, or from about 20 cSt to about 4,000 cSt, or from about 100 cSt to about 3,000 cSt.

The concentration of the at least one silicone polyether is generally from about 0.02 to about 30 wt %, or from about 0.05 to about 25 wt %, or from about 0.1 to about 20 wt %, or from about 0.2 to about 15 wt %, or from about 0.5 to about 12 wt %, or from about 1 to about 10 wt %, of the composition, excluding the weight of volatile components. The at least one silicone polyether is generally from about 0.05 to about 30 wt %, or from about 0.1 to about 25 wt %, or from about 0.2 to about 20 wt %, or from about 0.5 to about 15 wt %, or from about 1 to about 12 wt %, or from about 2 to about 10 wt %, of the composition, excluding the weight of any solvents, fillers, and fibers.

The concentration of the at least one silicone polyether may be matched to that of the surface of the filler. It may be desirable to match the silicone polyether to the surface of the filler such that it forms a monolayer on the free surface of the filler. The silicone polyether may be matched with the surface of the filler to achieve a desired morphology.

The concentration of the at least one silicone polyether matched to the surface of the filler may depend on the particle size of the filler. In one embodiment, the concentration of the silicone polyether is from about 100 wt % to about 0.05 wt % by weight of filler, or from about 50 wt % to about 0.1 wt % by weight of filler, or from about 25 wt % to about 0.5 wt % by weight of filler. The desired ratios of filler to silicone polyether may be determined empirically. For example, in the case of AOH, when the concentration of the filler is 15 wt %, the concentration of the silicone polyether may range from about 1 wt % to about 3 wt % by weight of formulation, excluding solvents or other volatile compounds. In one embodiment, talc may be used as a filler. In such instances, the concentration of filler may be 15%, and the optimal range for the silicone polyether is from about 0.25 to about 0.5 wt % by weight of the formulation, excluding solvents and other volatile products.

The first thermosetting resin may comprise a resin selected from epoxy resins, isocyanate resins, (meth)acrylic resins, phenolic resins, melamine resins, vinylic resins, vinylester resins, styrenic resins, silicone resins, and polyester resins. In a preferred embodiment, the first thermosetting resin is an epoxy resin. The thermosetting composition of the invention may further comprise at least one hardener for the at least one thermosetting resin. Hardeners may be chosen from, but are not limited to, amines, phenolic resins, carboxylic acids, carboxylic anhydrides, and polyol resins. In a preferred embodiment, the thermosetting resin is different from the hardener. In embodiments wherein the first thermosetting resin comprises an epoxy resin, the at least one hardener is preferably chosen from amines, phenolic resins, carboxylic acids, and carboxylic anhydrides. In embodiments wherein the first thermosetting resin comprises an isocyanate, the at least one hardener is preferably chosen from polyols.

The thermosetting composition may be water-based. Water-based thermosetting compositions may allow the silicone polyether to permeate across solid surfaces. For example, interaction with the silicone polyether may be enhanced with a water-based epoxy. A water-based thermosetting composition may also achieve faster and enhanced migration to silicone and silicone-like surfaces. In addition, water-based thermosetting compositions may enable better orientation of the silicone polyether to the filler.

The thermosetting composition of the invention may further include at least one catalyst for polymerization, including homopolymerization, of the at least one thermosetting resin, or for a reaction between the at least one thermosetting resin and the at least one hardener. The thermosetting composition may further include a second thermosetting resin different from the first thermosetting resin and different from the at least one hardener. The thermosetting composition may further include at least one solvent. The thermosetting composition according to the invention may further include one or more additives chosen from toughening agents, curing inhibitors, wetting agents, colorants, thermoplastics, processing aids, dyes, UV-blocking compounds, and fluorescent compounds. This list is intended to be exemplary and not limiting.

The thermosetting composition may further include one or more fillers or fibrous reinforcements. The filler may be inorganic, organic, or mixed organic/inorganic. In a further embodiment, the filler may be a flame retardant. Examples of fillers include, but are not limited to, inorganic fillers, including, but not limited to, silica, talc, quartz, mica, aluminum trihydroxide, magnesium hydroxide, and boehmite. An example of an organic filler is ammonium polyphosphate. An example of a mixed organic/inorganic filler is aluminum phosphinate. Examples of flame-retardant fillers are aluminum trihydroxide, magnesium hydroxide, and boehmite. The concentration of the filler, such as inorganic filler, may range from about 1 to about 95 wt %, or from about 2 to about 90 wt %, or from about 5 to about 85 wt %, or from about 10 to about 80 wt %, or from about 15 to about 75 wt %, based on the total weight of the composition. The average particle size of the inorganic filler will generally be less than about 1 mm, such as less than about 100 microns, or less than about 50 microns, or even less than about 10 microns. The average particle size of the inorganic filler may be greater than about 2 nm, or greater than about 10 nm, or greater than about 20 nm, or greater than about 50 nm.

Fillers can also be pre-coated with the compositions described herein. In one embodiment, the compositions can be used to coat the surface of fillers, thus creating modified fillers that show enhanced toughening when compared to non-coated fillers. Methods which incorporate the pre-coating of filler can provide an efficient deposition of toughening reagent into the composition. Not only does such a method provide for use of desired amounts of toughening agent, it also avoids the migration of excess reagent to other surfaces of the formulation.

In another embodiment, the filler is glass and the glass surface can be modified with the silicone polyether. For example, when the filler is a glass weave, the filler can be impregnated with the toughening agent. In one embodiment, the silicone polyether may be introduced into the system by coating the glass surface of the glass weave that is used in the glass-reinforced plastic with the silicone polyether. In another embodiment, surface defects of prepregs can be modified by lowering the surface tension with the use of the silicone polyethers described herein.

The thermosetting compositions of the instant invention have higher toughness when compared to neat thermosetting networks. Unlike compositions comprising conventional toughening agents, uncured compositions comprising the silicone polyethers described herein do not exhibit lower viscosity when combined with filler, leading to better processability and easier handling. The effective use level of the silicone polyether resins in conjunction with fillers is very low compared to other toughening reagents like rubber or block co-polymers. The lower viscosity of the silicone polyethers as compared to other toughening agents also enables higher load levels of filler, while maintaining high processability and mechanical properties. The silicone polyethers in the thermoset networks of the invention also enable an improved coefficient of thermal expansion of laminate boards without sacrificing other properties.

The instant compositions also exhibit excellent mechanical properties when used in combination with filler. In contrast, the use of conventional thermoplastic block polymer such as rubber-containing block polymer fails to improve the toughness of silica-filled epoxy networks.

Without wishing to be bound by any particular theory of operation, the silicone polyether morphology appears to be controlled by the orientation of the silicone portion to the filler particle. This leaves the polyether structure free to interact with the epoxy matrix for enhanced toughness.

### Base Materials for Printed Wire Boards and Other Thermoset Products

Also provided by the present invention are base materials for printed wire boards and other thermoset products that may include a) one or more thermoset networks, and b) one or more silicone polyethers, wherein the silicone polyether comprises the structure (I) shown above, where the variables have the meanings described above, and methods of making the same. The base materials and thermoset products can also include at least one filler, fibrous reinforcement, or aspect shaped inorganic material.

The invention also includes methods of making a thermoset product comprising combining:

a) at least a first thermosetting resin
b) at least one silicone polyether, wherein the silicone polyether comprises the following structure (I):

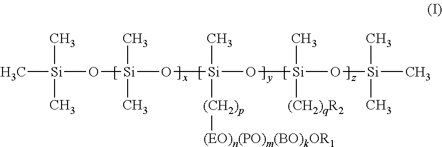

wherein x, y, z, p, q, k, m, and n are independent integers; x and y are greater than or equal to 1; z is greater than or equal to 0; p and q are greater than or equal to 1; k, n, and m are greater than or equal to 0 and the sum of k+n+m is greater than or equal to 1; R₁ and R₂ are independent end groups chosen from H or H function groups comprising —OH, —NH2 or NHR, (CH2)nCH3 where n is an integer greater than or equal to 0 and R represents any one of the alkyl groups, acetate, and (meth)acrylate; and EO is ethylene oxide, PO is propylene oxide, and BO is butylene oxide; and
c) at least one filler, fibrous reinforcement or aspect-shaped inorganic material;
and curing the first thermosetting resin and the at least one silicone polyether to form a thermoset product.

### Utility and Practical Applications

The present base materials and thermoset products find use in any application in which a tough and mechanically stress-resistant network is desired, especially those in which a filler or fibrous reinforcement is included. The thermoset product can be formed from any of the thermosetting compositions comprising a) at least a first thermosetting resin, with b) at least one silicone polyether, wherein the silicone polyether comprises the structure (I) shown above, where the variables have the meanings described above; and c) at least one filler or fibrous reinforcement.

General applications of the invention include, for example, casting, potting, coating, and encapsulation. The instant invention may also be used in composites, laminates and coatings. More specific uses include electrical or electronic castings; electrical or electronic pottings; electrical or electronic encapsulations; electrical or decorative laminates; structural composites; machined reinforced plastic components; pre-impregnated materials based on woven glass fabric impregnated with epoxy, melamine, or silicone resins for tube winding or molding applications; machined parts from composites and tubes; high tech plastics made of laminated paper; laminated fabric as sheets; tubes; rods; duroplastic semi-finished products; photo- and solder resists; synthetic resin bonded tubes; protective coatings, conformal coatings; and decorative coatings.

The thermoset networks prepared from compositions containing silicon polyether resins are also suitable for high performance applications like printed wire boards, resins coated copper foil and IC-substrates.

The thermoset networks prepared according to the present invention are especially suitable for use in electrical insulation composites such as printed wire boards.

The following examples are illustrative of the present invention, and are not to be construed as limiting the scope of the invention. Variations and equivalents of these examples will be apparent to those of skill in the art in light of the present disclosure. Unless otherwise stated, all percentages are by weight of the total composition.

### EXAMPLES

Various terms, abbreviations and designations for the raw materials and tests used in the following Examples are explained as follows:

### Abbreviations

DOWANOL™ PMA is a propylene glycol methyl ether acetate, commercially available from The Dow Chemical Company.

DOWANOL™ PM is a propylene glycol methyl ether, commercially available from The Dow Chemical Company.

SPE stands for silicone polyether

SBM stand for Poly(Styrene-Butadien-(methyl)Methacrylate)

DC followed by four digit number (such as DC 5097) are products from Dow Corning. The molecular weight values throughout the present application are calculated based on the published molecular weight values of these Dow Corning products.

TBBA stands for tetrabromobisphenol A.

MEK stands for methyl ethyl ketone.

DMTA stands for dynamic mechanical thermal analysis.

SBM stands for styrene-butadiene-methacrylate copolymer.

Td stands for thermal degradation temperature.

Tg stands for glass transition temperature.

CTE Coefficient of thermal expansion.

TABLE 1
Test Methods

| Test No. | Description | Comments |
|---|---|---|
| 2.3.10B | Flammability of Laminate - 12/94 | |
| 2.4.8C | Peel Strength of Metallic Clad Laminates--12/94 | |
| 2.4.24.1 | Time to Delamination (TMA Method)--12/94 | T 288 |
| 2.4.24.6 | Decomposition Temperature (Td) of Laminate | |
| | Material Using TGA - 4/06 | |
| 2.4.30 | Impact Resistance, Polymer Film-10/86 | Similar to this test method a dropping weight |
| | | has been used to measure the energy to |
| | | delamination |
| 2.4.24C | Glass Transition Temperature and Z-Axis Thermal | CTEz |
| | Expansion by TMA--12/94 | |
| 2.4.24.4 | Glass Transition and Modulus of Materials Used in | |
| | High Density Interconnection (HDI) and Microvias- | |
| | DMA Method - 11/98 | |
| 2.4.11 | Shear Strength Flexible Dielectric Materials--4/73 | Instead of the Tinus-Olsen Super “L” Tester a |
| | | clamp from www.knu-vise.com has been used. |
| | | Ratings were established as follows: |
| | | 1 = Cross. Can be broad in its appearance. |
| | | 2 = Cross plus delaminated area inside the |
| | | cross. |
| | | 3 = Cross plus delaminated area. The |
| | | delaminated area is round and reaching over |
| | | the cross limits. |
| 2.4.24.6 | Decomposition Temperature (Td) of Laminate | |
| | Material Using TGA-4/06 | |
| 2.4.40 | Inner Layer Bond Strength of Multilayer Printed | This test method has been used to measure |
| | Circuit Boards--10/87 | the first ply adhesion as described in the |
| | | method but also for the 4^{th} ply adhesion, i.e. |
| | | the middle layer adhesion |
| 2.6.2C | Moisture Absorption, Flexible Printed Wiring--5/98 | |
| 2.6.16 | Pressure Vessel Method for Glass Epoxy Laminate | This method has been used to determine the |
| | Integrity--7/85 | water pick up. Calculations have been used |
| | | from the test method 2.6.2c |

### Test Systems

Two test systems were formulated. The formulations are called LF 150 and E-BPAN in the following description. The first test system, LF 150, has been formulated as shown in the following table:

TABLE 2

| | Clear |
|---|---|
| LF 150 System | System |
| EPOXY RESIN SOLUTION (XQ 82955.01, | 963.9 |
| available from Dow Chemical Co., composed of a | |
| Brominated Epoxy Resin and Epoxy Novolac | |
| in a solution of Butanone, Methyl ethyl ketone, | |
| and Acetone | |
| Epoxide Eq. Wt., on resin 250-280 [~75% solid | |
| content] | |
| EPOXY RESIN HARDENER (XZ92745.01, | 461.8 |
| available from Dow Chemical Co., | |
| composed of Phenol A Novolac resin blend with | |
| tetrabromobisphenol A a in a mixture of | |
| DOWANOL ™ PM and PMA | |
| [~60% solid content] | |
| 2-methyl-imidazole | 1.7 |
| [20% N/V] | |
| Additional DOWANOL ™ PMA | 60 |
| TOTAL SOLIDS + | 1000 |
| TOTAL NON-SOLIDS | 487 |
| TOTAL SOLUTION | 1487 |
| % SOLIDS | 67.3% |
| DIN 4 Viscosity | 56 |
| Gel Time: | 246 |

The second test system, E-BPAN, has been formulated as shown in the following table:

TABLE 3

| Epoxy Bisphenol A Novolac (E-BPAN System) (RTC | |
|---|---|
| 200700753 Exp19, available from Dow Chemical Co.) | |
| In a similar fashion also EBPAN-20 from Nippon | Clear |
| Kayaku could be used | System |
| E-BPAN Epoxy resin solution (RTC 200503310-35, | 36.47 |
| available from Dow Chemical Co.) | |
| [~78.2% NV in MEK][EEW on solid ~ 202.0] | |
| TBBA + Bisphenol A Novolac (Rezicure (4000)) | 34.07 |
| Hardener [~60.0% nv in MEK/PM] | |
| 2-methylimidazole | 0.07 |
| [~20% in Dowanol PM] | |
| TOTAL SOLIDS + | 56.3 |
| TOTAL NON-SOLIDS | 21.6 |
| TOTAL SOLUTION | 78.0 |
| % SOLIDS | 72.25 |
| Additional Dowanol PM | 8.00 |
| TOTAL SOLUTION | 85.96 |
| % SOLIDS: | 65.52 |
| Gel Time: | 276 |

The so produced varnishes were used to impregnate glass weave (7628 glass style) on a horizontal Caratsch treater.

The above formulations, modified with fillers and silicone polyethers at different ratios, were run over a treater with typical settings as follows: typical air pressures applied to the treater were in the range from about 170° C. to about 180° C.; typical gap settings of the squeeze rolls were from about 0.35 to about 0.45 mm; typical speed of the glass that was carried through the machine was from about 1.0 to about 2.0 m/min

These conditions reached prepreg of the following typical parameters: gel time of from about 50 to about 150 sec; minimum viscosity of from about 20 to about 100 PaS; flow of from about 20 to about 30%.

The prepregs were stacked to 8 sheets and covered with copper. This set up was pressed out in a multilayer press for 90 min at 190° C. at 15 KN7 sqm to yield copper clad laminates which were analyzed for toughness, water resistance, flammability, and other properties.

Table 4 illustrates a number of different LF 150 resin system thermosetting compositions:

TABLE 4

| | Resin | Filler | Filler | Modifier | Modifier |
|---|---|---|---|---|---|
| Example | System | Type | Load | Type | Loading |
| 1 | LF150 | None | 0 | SBM | 5 |
| 2 | LF150 | Talc | 15 | None | 0 |
| 3 | LF150 | Talc | 15 | SBM | 5 |
| 4 | LF150 | AOH20 | 15 | None | 0 |
| 5 | LF150 | AOH20 | 15 | SBM | 5 |
| 6 | LF150 | AOH20 | 15 | DC 5097 | 5 |
| 7 | LF150 | AOH20 | 15 | DC 5247 | 5 |
| 8 | LF150 | None | 0 | None | 0 |
| 9 | LF150 | AOH20 | 15 | DC 5097 | 1 |
| 10 | LF150 | AOH20 | 15 | DC 5247 | 1 |
| 11 | LF150 | AOH20 | 15 | DC 5097 | 3 |
| 12 | LF150 | AOH20 | 15 | DC 5247 | 3 |
| 13 | LF150 | AOH20 | 15 | None | 0 |
| 14 | LF150 | AOH20 | 15 | DC 5097 | 5 |
| 15 | LF150 | AOH20 | 15 | DC 5247 | 5 |
| 16 | LF150 | None | 0 | DC 5097 | 5 |
| 17 | LF150 | None | 0 | DC 5247 | 5 |
| 18 | LF150 | None | 0 | None | 0 |
| 19 | LF150 | Talc | 15 | None | 0 |
| 20 | LF150 | Talc | 15 | SBM | 5 |
| 21 | LF150 | Talc | 15 | DC 5097 | 5 |
| 22 | LF150 | Talc | 15 | DC 5247 | 5 |
| 23 | LF150 | Talc | 15 | DC 5097 | 2.5 |
| 24 | LF150 | Talc | 15 | DC 5247 | 2.5 |
| 25 | LF150 | None | 0 | DC 5247 | 0.2 |
| 26 | LF150 | None | 0 | DC 5247 | 0.2 |

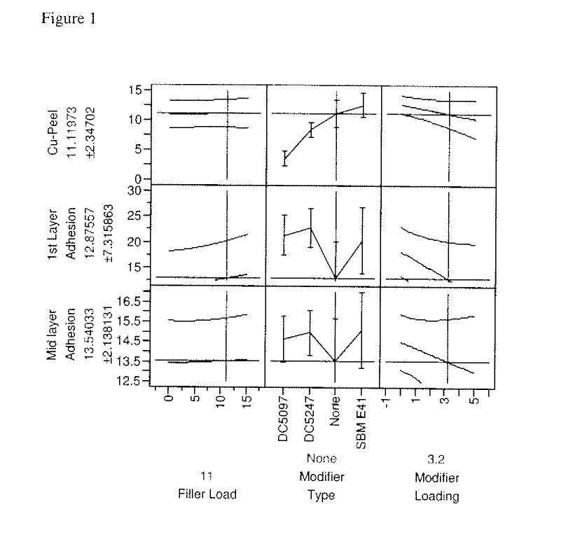

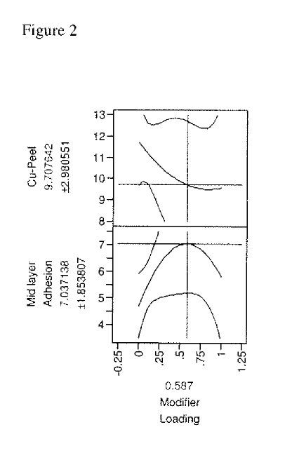

Each of the different thermosetting compositions from Table 3 was analyzed for adhesion, Cu-peel, punch, and other properties. FIGS. 1 and 2 provide exemplary statistical results for Cu-peel and adhesion. DC5097 and DC5247 give similar improvement in first and mid layer adhesion as SBM, while Cu-peel suffers with DC products (FIG. 1). In the non-filled formulation the Cu-peel strength fades with increased DC Product usage, although Cu-peel strength is retained with addition of filler until the optimum usage level of the DC product for improved toughness (FIG. 2).

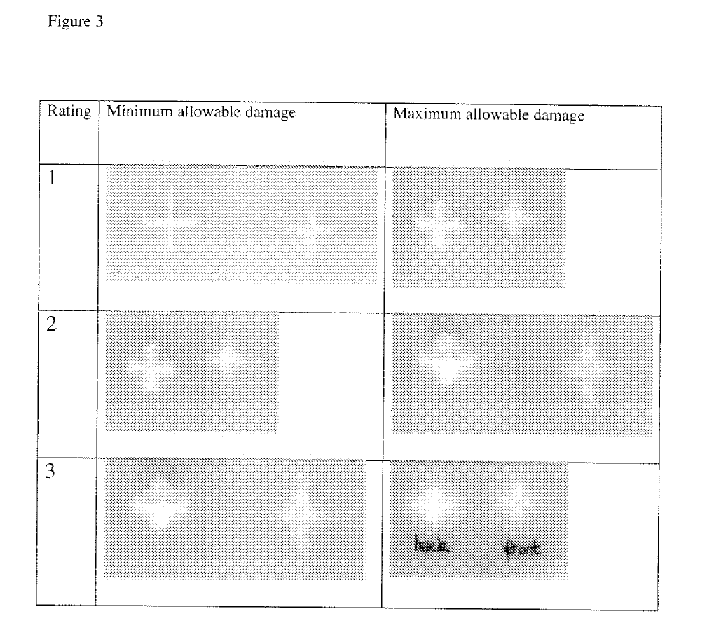

Punch ratings were determined as follows: a rating of 1 indicates cross without delamination; a rating of 2 indicates cross with delamination; and a rating of 3 indicates cross with delamination where the delaminated area is larger or equal to the cross dimension. Minimum and maximum allowable damages as they correspond to the punch ratings are shown in FIG. 3.

A summary of the results for each of the exemplary LF150 resin system compositions may be found in Tables 5 and 6.

TABLE 5

| | | | | | Energy to | | 1st Layer | Mid Layer |
|---|---|---|---|---|---|---|---|---|
| | Td | Tg | T288 | | delam | Cu-Peel | Adhesion | Adhesion |
| | [deg C.] | [deg C.] | [min] | Punch | [J] | [N/cm] | [N/cm] | [N/cm] |
| | IPC Test Methods | | | | | | | |
| Example | 2.4.24.6 | 2.4.24 | 2.4.24 | 2.4.11 | 2.4.30 | 2.4.8C | 2.4.8C | 2.4.8C |
| 1 | 333 | 160 | 8 | 1 | | 12.3 | 17.4 | 15 |
| 2 | 336 | 156 | 16 | 3 | | 14 | 16 | 10 |
| 3 | 332 | 156 | 11 | 2 | | 11 | 14 | 7 |
| 4 | 335 | 158 | 14 | 2 | | 14 | 17 | 14 |
| 5 | 335 | 154 | 11 | | | 11 | 16 | 14 |
| 6 | 339 | 153 | 17.5 | 3 | | 2.5 | 15 | 15 |
| 7 | 339 | 157 | 16 | 2 | | 9 | 21 | 14 |
| 8 | 334 | 162 | 15 | 3 | | 12 | 16 | 15 |
| 9 | 338 | 158 | | 3 | | 6.5 | 28 | 15.5 |
| 10 | 339 | 163 | | 2 | | 8 | 22.5 | 16.6 |
| 11 | 338 | 161 | 17 | 2 | | 3.4 | 28 | 13 |
| 12 | 338 | 162 | | 2 | | 8.4 | 23 | 14.7 |
| 13 | 336 | 163 | 14 | | | 12 | 21 | 14.5 |
| 14 | 337 | 155 | 18 | 2 | | 1.9 | 18.5 | 15.8 |
| 15 | 338 | 157 | 17 | 1 | | 7.8 | 24.3 | 14.7 |
| 16 | 339 | 154 | 17 | 2 | | 2.1 | 13 | 13 |
| 17 | 336 | 157 | 15 | 1 | | 7.5 | 19 | 14 |
| 18 | 342 | 137 | | 1 | 3.56 | 14.2 | | 7.6 |
| 19 | 343 | 132 | | 3 | 0.89 | 12.8 | | 6 |
| 20 | 333 | 135 | | 3 | 0.89 | 10.5 | | 5.1 |
| 21 | 340 | 133 | | 2 | 1.78 | 1.5 | | 6.1 |
| 22 | 342 | 136 | | 2 | 1.78 | 7.7 | | 7.5 |
| 23 | | 135 | | 2 | 1.72 | 1.7 | | 5.9 |
| 24 | | 136 | | 2 | 1.72 | 11.4 | | 6.4 |
| 25 | | | | | | 16.2 | | 11.5 |
| 26 | | | | | | 8.7 | | 11.8 |

TABLE 6

| | Modulus < Tg | Modulus > Tg | DMTA Tg | CTE < Tg | CTE > Tg | Water Uptake | Water Uptake |
|---|---|---|---|---|---|---|---|
| | [E\hat{ }9 Pa] | [Pa] 2 | [° C.] | [ppm/k] | [ppm/k] | (1 hr) [%] | (2 hr) [%] |
| | IPC Test Methods | | | | | | |
| Example | 2.4.24.4 | 2.4.24.4 | 2.4.24.4 | 2.4.24C | 2.4.24C | 2.6.16 | 2.6.16 |
| 1 | 21 | 7.5 | 176 | 68 | 288 | 0.18 | 0.28 |
| 3 | | | | 63 | 286 | | |
| 4 | 18 | 7 | 170 | 46 | 266 | 0.25 | |
| 5 | 19 | 6.5 | 173 | 63 | 286 | | |
| 6 | 23 | 8 | 170 | 55 | 321 | 0.3 | 0.35 |
| 7 | 21 | 8 | 175 | 40 | 275 | 0.25 | 0.32 |
| 8 | 23 | 9.4 | 176 | 61 | 314 | 0.19 | 0.22 |
| 9 | 26 | 1.2 | 176 | 52 | 284 | 0.26 | |
| 10 | 25 | 1.2 | 175.5 | | | | 0.26 |
| 11 | 25 | 1.1 | 173 | 47 | 247 | 0 | 0.3 |
| 12 | 24 | 1 | 175.6 | | | | 0.28 |
| 13 | 22 | 1.1 | 176 | 46 | 266 | | |
| 14 | 25 | 9.4 | 170 | 55 | 321 | 0.3 | 0.35 |
| 15 | 24 | 9.3 | 173 | 36 | 275 | 0.25 | 0.32 |
| 16 | 23 | 1.2 | 170 | 61 | 236 | 0.22 | 0.31 |
| 17 | 23 | 8.4 | 173 | 50 | 278 | 0.2 | 0.35 |
| 18 | 18 | 8 | 155 | | | | |
| 19 | 24 | 1.25 | 144 | | | | |
| 21 | 19.5 | 7 | 151.6 | | | | |
| 23 | 19.9 | 10 | 164 | | | | |
| 24 | 21.7 | 10 | 160 | | | | |

In addition, flammability testing showed that the thermosetting compositions both with and without the addition of filler were highly flame-retardant. Table 7 summarizes the results for three LF 150 resin system thermosetting compositions. Each achieved a UL94 class VO rating.

TABLE 7

| | | | Filler | Modifier | Modifier | Flammability | Flammability | Total |
|---|---|---|---|---|---|---|---|---|
| | Resin | Filler | Load | Type | Loading | 1^{st} burn | 2^{nd} burn | Flammability |
| | System | Type | [%] | (SiO/EO/PO) | [%] | [sec] | [sec] | [sec]. |
| Example | IPC Test methods Reference 2.3.10B | | | | | | | |
| 4 | LF150 | AOH20 | 15 | None | 0 | 2 | 16 | 18 |
| 8 | LF150 | None | 0 | None | 0 | 3 | 19 | 22 |
| 14 | LF150 | AOH20 | 15 | DC 5097 | 5 | 1 | 17 | 18 |

Table 8 illustrates a number of different E-BPAN resin system thermosetting compositions:

TABLE 8

| | | | Filler | | Modifier |
|---|---|---|---|---|---|
| | Resin | Filler | Load | Modifier | Loading |
| Example | System | Type | [%] | Type | [%] |
| 27 | E-BPAN | None | 0 | None | 0 |
| 28 | E-BPAN | Talc | 15 | None | 0 |
| 29 | E-BPAN | None | 0 | DC 5247 | 5 |
| 30 | E-BPAN | Talc | 15 | DC 5247 | 5 |
| 31 | E-BPAN | None | 0 | DC 5247 | 1 |
| 32 | E-BPAN | Talc | 1 | DC 5247 | 1 |
| 33 | E-BPAN | None | 0 | DC 5247 | 0.1 |
| 34 | E-BPAN | None | 0 | DC 5247 | 0.1 |
| 35 | E-BPAN | None | 0 | DC 5247 | 0.5 |
| 36 | E-BPAN | Talc | 15 | DC 5247 | 0.5 |
| 37 | E-BPAN | None | 0 | None | 0 |
| 38 | E-BPAN | Talc | 15 | None | 0 |
| 39 | E-BPAN | Talc | 15 | DC 5247 | 0.1 |
| 40 | E-BPAN | Talc | 15 | DC 5247 | 0.1 |
| 41 | E-BPAN | Talc | 15 | DC 5247 | 0.2 |
| 42 | E-BPAN | coated | 15 | DC 5247 | |
| | | Talc | | Coated | |
| 43 | E-BPAN | SiO2 | 15 | DC 5247 | 0.2 |
| 44 | E-BPAN | SiO2 | 15 | DC 5247 | |
| | | coated | | | |
| 45 | E-BPAN | Talc | 15 | None | 0 |
| 46 | E-BPAN | Talc | 15 | DC 5247 | 1 |
| 47 | E-BPAN | Talc | 15 | DC 5247 | 0.5 |

The thermosetting compositions from Table 8 were also analyzed for adhesion, punch, and other properties. A summary of the results for exemplary E-BPAN resin system compositions may be found in Table 9.

TABLE 9

| | Contact | | | | Energy to | | Mid layer |
|---|---|---|---|---|---|---|---|
| | Angle | Tg | T288 | Punch | delam | Cu-Peel | Adhesion |
| Example | [°] | [deg C.] | [min] | Rating | [J] | [N/cm] | [N/cm] |
| 27 | 79.5 | | | | | | |
| 28 | 98 | | | | | | |
| 29 | 78.5 | | | | | | |
| 30 | 87.5 | | | | | | |
| 31 | 75 | | | 2 | | 11.1 | |
| 32 | 87.5 | | | 3 | | 9.7 | |
| 33 | 82.5 | | | 2 | | 10.9 | |
| 34 | 104.5 | | | 3 | | 11.3 | |
| 35 | | | | 2 | | 11.6 | |
| 36 | | | | 2 | | 10.2 | |
| 37 | | 193 | | | 1.72 | 12 | 3.9 |
| 38 | | 188 | | | 1.72 | 12.4 | 4.2 |
| 39 | | 194 | | | 1.72 | 11.8 | 4.8 |
| 40 | | 194 | | | 1.72 | 12.4 | 4.8 |
| 41 | | | | 2 | | 12.4 | 7.4 |
| 42 | | | | 2 | | 11.6 | 6.3 |
| 43 | | | | 3 | | 8.1 | 6.3 |
| 44 | | | | 3 | | 11.9 | 6.4 |
| 45 | | 193 | | | 1.71 | 9.9 | 6.1 |
| 46 | | 195 | | 3 | 1.71 | 9.6 | 5.9 |
| 47 | | 194 | | 3 | 1.71 | 9.9 | 6.4 |

Although the present invention has been described in considerable detail with regard to certain versions thereof, other versions are possible, and alterations, permutations, and equivalents of the versions shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

1. A thermosetting composition comprising
a) at least a first thermosetting resin,
b) at least one silicone polyether, wherein the silicone polyether comprises the following structure: 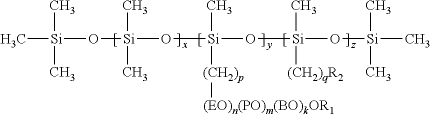
wherein x, y, z, p, q, k, m, and n are independent integers; x and y are greater than or equal to 1; z is greater than or equal to 0; p and q are greater than or equal to 1; k, n, and m are greater than or equal to 0 and the sum of k+n+m is greater than or equal to 1; R₁ and R₂ are independent end groups chosen from H or H function groups comprising —OH, —NH2 or NHR, (CH2)nCH3 where n is an integer greater than or equal to 0 and R represents an alkyl group, acetate, and (meth)acrylate; and EO is ethylene oxide, PO is propylene oxide, and BO is butylene oxide; and
c) at least one filler or at least one fibrous reinforcement.

2. The thermosetting composition according to claim 1, wherein the first thermosetting resin comprises a resin selected from epoxy resins, isocyanate resins, (meth)acrylic resins, phenolic resins, melamine resins, vinylic resins, vinylester resins, styrenic resins, silicone resins, and polyester resins.

3. The thermosetting composition according to claim 1, further comprising at least one hardener for the at least one thermosetting resin.

4. The thermosetting composition according to claim 3, wherein the at least one hardener is chosen from amines, phenolic resins, carboxylic acids, carboxylic anhydrides, and polyol resins, provided that the thermosetting resin is different from the hardener.

5. The thermosetting composition according to claim 1, further comprising at least one catalyst for polymerization of the at least one thermosetting resin, or for a reaction between the at least one thermosetting resin and the at least one hardener.

6. The thermosetting composition according to claim 1, further comprising a second thermosetting resin different from the first thermosetting resin and different from the at least one hardener.

7. The thermosetting composition according to claim 1, further comprising at least one solvent.

8. The thermosetting composition according to claim 1, further comprising at least one additive chosen from toughening agents, curing inhibitors, wetting agents, colorants, thermoplastics, processing aids, dyes, UV-blocking compounds, and fluorescent compounds.

9. The thermosetting composition according to claim 1, wherein the composition is water-based.

10. The thermosetting composition according to claim 9, wherein the silicone polyether migrates solid surfaces in the composition.

11. The thermosetting composition according to claim 1, wherein z ranges from 0 to 50.

12. The thermosetting composition according to claim 1, wherein p and q are independent and range from 1 to 10.

13. The thermosetting composition according to claim 1, wherein the sum of n+m is greater than or equal to 1 and k equals 0.

14. The thermosetting composition according to claim 1, wherein R₁ and R₂ are independent end groups chosen from H or H function groups comprising —OH, —NH2 or NHR, (CH2)nCH3 and CH₃, where n is an integer greater than or equal to 0 and R represents an alkyl group and acetate.

15. The thermosetting composition according to claim 1, wherein x, y, p, and q are independently chosen such that the average molecular weight of the at least one silicone polyether is from about 400 to about 100,000.

16. The thermosetting composition according to claim 1, wherein x, y, p, and q are independently chosen such that the percentage by weight of silicone backbone in the at least one silicone polyether is from about 5% to about 95%.

17. The thermosetting composition according to claim 1, wherein x, y, p, and q are independently chosen such that the average molecular weight of the silicone backbone in the at least one silicone polyether is from about 200 to about 30,000.

18. The thermosetting composition according to claim 1, wherein the thermosetting composition comprises an inorganic filler selected from the group consisting of silica, talc, quartz, and mica.

19. The thermosetting composition according to claim 1, wherein the thermosetting composition comprises an inorganic filler which is a flame retardant selected from the group consisting of aluminum trihydroxide, magnesium hydroxide, and boehmite.

20. The thermosetting composition according to claim 18, wherein the concentration of the inorganic filler is from about 1 to about 95 wt % based on the total weight of the composition.

21. The thermosetting composition according to claim 18, wherein the average particle size of the inorganic filler is less than about 1 mm.

22. (canceled)

23. The thermosetting composition according to claim 1, wherein the concentration of the at least one silicone polyether is from about 0.05 to about 30 wt % of the composition, excluding the weight of any solvents, fillers, and fibers.

24. The thermosetting composition according to claim 1, wherein the viscosity of the at least one silicone polyether, when measured at 25° C., is from about 1 cSt to about 50,000 cSt.

25. The thermosetting composition according to claim 1, wherein the concentration of the at least one silicone polyether is matched to that of the filler.

26. The thermosetting composition according to claim 25, wherein when the concentration of the filler is 15 wt %, the concentration of the silicone polyether may range from about 1 wt % to about 3 wt % by weight of formulation excluding solvents or other volatile compounds.

27. A base material for printed wire boards comprising a) at least one thermoset network, b) at least one silicone polyether, wherein the silicone polyether comprises the following structure: 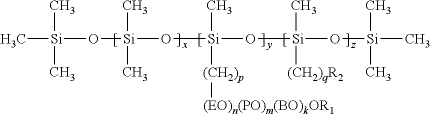
wherein x, y, z, p, q, k, m, and n are independent integers; x and y are greater than or equal to 1; z is greater than or equal to 0; p and q are greater than or equal to 1; k, n, and m are greater than or equal to 0 and the sum of k+n+m is greater than or equal to 1; R₁ and R₂ are independent end groups chosen from H or H function groups comprising —OH, —NH2 or NHR, (CH2)nCH3 where n is an integer greater than or equal to 0 and R represents an alkyl group, acetate, and (meth)acrylate; EO is ethylene oxide, PO is propylene oxide, and BO is butylene oxide; and c) at least one filler.

28. Use of the base material of claim 27 in the production of printed wire boards.

29. A thermoset product comprising:
a) at least one thermoset network,
b) at least one silicone polyether, wherein the silicone polyether comprises the following structure: 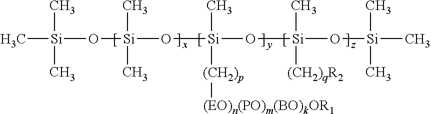
wherein x, y, z, p, q, k, m, and n are independent integers; x and y are greater than or equal to 1; z is greater than or equal to 0; p and q are greater than or equal to 1; k, n, and m are greater than or equal to 0 and the sum of k+n+m is greater than or equal to 1; R₁ and R₂ are independent end groups chosen from H or H function groups comprising —OH, —NH2 or NHR, (CH2)nCH3 where n is an integer greater than or equal to 0 and R represents an alkyl group, acetate, and (meth)acrylate; EO is ethylene oxide, PO is propylene oxide, and BO is butylene oxide; and
c) at least one filler, fibrous reinforcement, or aspect shaped inorganic material.

30. Use of the thermoset product according to claim 29 in any one of a casting, potting, encapsulation, coating, composite, and/or laminate.

31. A thermoset product formed from the thermosetting composition according to claim 1.

32. A method of making a thermoset product comprising combining a) at least a first thermosetting resin, b) at least one silicone polyether, wherein the silicone polyether comprises the following structure: 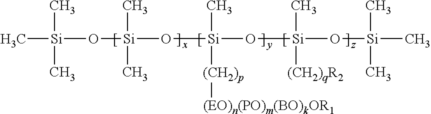
wherein x, y, z, p, q, k, m, and n are independent integers; x and y are greater than or equal to 1; z is greater than or equal to 0; p and q are greater than or equal to 1; k, n, and m are greater than or equal to 0 and the sum of k+n+m is greater than or equal to 1; R₁ and R₂ are independent end groups chosen from H or H function groups comprising —OH, —NH2 or NHR, (CH2)nCH3 where n is an integer greater than or equal to 0 and R represents an alkyl group, acetate, and (meth)acrylate; and EO is ethylene oxide, PO is propylene oxide, and BO is butylene oxide; and c) at least one filler; and
curing the first thermosetting resin and the at least one silicone polyether to form a thermoset product.

33. The thermosetting composition according to claim 1, wherein the filler is organic.

34. (canceled)

35. The thermosetting composition according to claim 1, wherein the filler is mixed organic/inorganic.

36. (canceled)
